(19) United States
(12) Patent Application Publication
(10) Pub. No.: US 2018/0140918 A1
(43) Pub. Date: May 24, 2018

(54) SYSTEM FOR USING VR GLASSES IN SPORTS

(71) Applicant: JULIE BILBREY, GALLATIN, TN (US)

(72) Inventor: JULIE BILBREY, GALLATIN, TN (US)

(21) Appl. No.: 15/357,713

(22) Filed: Nov. 21, 2016

(51) Int. Cl. A63B 69/00; G09B 19/00; A63B 69/38; A63B 71/06; G06F 3/16; G06K 9/00

(52) U.S. Cl. CPC A63B 69/00; G09B 19/0038; A63B 69/0002; A63B 69/002; A63B 2071/063; A63B 69/38; A63B 71/0622; G06F 3/16; G06K 9/00671; A63B 69/0071

(57) ABSTRACT

Disclosed is a system for providing real-time match analysis to assist coach in changing scenarios from sidelines in a live game on the field. The system receives real-time media data from cameras placed on one or more athletes. The system includes a VR glass worn by the coach to view real-time media data from the cameras is able to view live scenarios of the live game on the field from sidelines, and a software application communicating with the VR glass. The software application allows the user to interact via social media platform on the live scenarios of the live game. Further, the software application communicates messages discussed on the social media platform to the VR glass. The VR glass then displays the messages on the social media platform to the software application. Further, the coach is able to manage the players on the field depending upon the messages shared on the social media platform.

### BACKGROUND OF THE INVENTION

### 1. Field of the Invention

The present invention generally relates to a system for using VR glasses in sports, and specifically using the VR glasses in training scenarios and potentially in live game play.

### 2. Description of Related Art

Sports clipboards are known in the art and are used by coaches to sketch and record plays. Coaches also keep copies of plays in notebooks, on laptop computers, handheld computing devices and elsewhere. During a game, a coach may have no direct access to recorded plays and no way to record new plays.

It is also known to photograph plays during a game and to cause these photos to be relayed to the coaching staff. These photos are normally printed out in hardcopy or displayed on a monitor. Current systems lack electronic ways to store and recall images of plays that the coach could carry or have immediately available.

Further with the growth of computer messaging or social media it is a need to invite suggestions from others to assist the coach in training and managing the players on the field. Examples of a social media or computer or communication platform may be similar to a twitter, email, “livechat,” or any other live messaging system, or even a voice messaging system for active voice communication, thus, these various systems may be referred to as a social media platform, since social media are just platforms that enable fast communication to single or multiple users from a single user, like singers, or movie stars that want to communicate to their followers.

Therefore, there is a need of a system to provide real-time player training or match analysis on a VR set to assist a coach in training players or changing scenarios from a sideline in a live game on the field. Furthermore, the system includes a software application in order to receive social media messages on the VR set to assist the coach in managing and training the players.

### SUMMARY OF THE INVENTION

The features of the invention that are believed to be novel are particularly pointed out and distinctly claimed in the concluding portion of the specification. These and other features, aspects, and advantages of the present invention will become better understood with reference to the following drawings and detailed description.

A system for providing real-time training of players to assist a coach in training players on how to play a game, the system comprising: a VR glasses worn by the player to view virtual reality game scenarios to play with; and a software application communicating with the VR glasses, allowing the coach to communicate with the player during the player's interaction with the virtual reality gam scenario.

These and other features and advantages will become apparent from the following detailed description of illustrative embodiments thereof, which is to be read in connection with the accompanying drawings.

### BRIEF DESCRIPTION OF DRAWINGS

To further clarify various aspects of some example embodiments of the present invention, a more particular description of the invention will be rendered by reference to specific embodiments thereof that are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 illustrates a block diagram of a system for providing real-time match analysis to assist coach in changing scenarios from sidelines in a live game played on the field; and

FIG. 2 illustrates a perspective view of a VR glass worn by the coach and communicating with the mobile application in accordance with a preferred embodiment of the present invention.

### DETAILED DESCRIPTION OF DRAWINGS

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

The following embodiments and the accompanying drawings, which are incorporated into and form part of this disclosure, illustrate embodiments of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

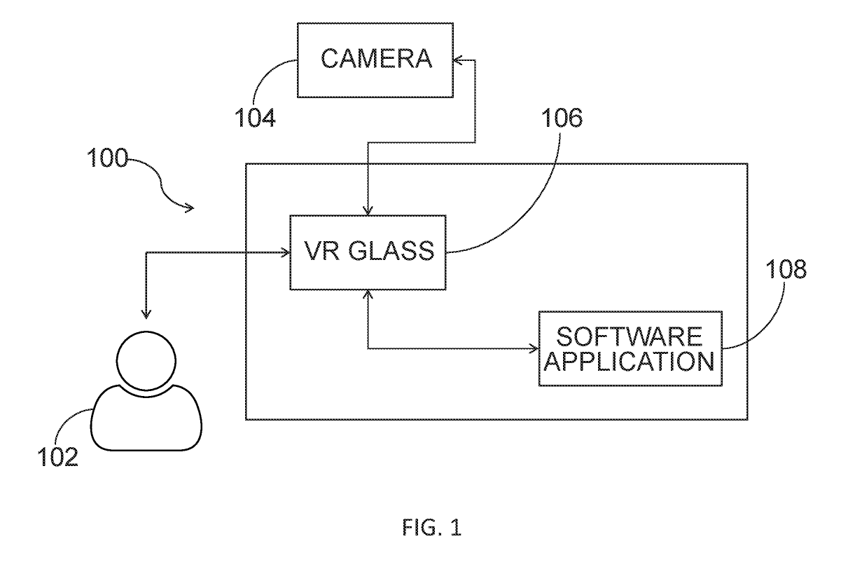

FIG. 1 illustrates a block diagram of a system 100 for providing real-time player communication to assist a coach 102 during training sessions, and changing scenarios from the sidelines in a live game. The system 100 may receive real-time data from cameras 104 placed on one or more athletes. For exemplary purposes, the cameras 104 may be attached to various objects such as clothes, helmet, glasses etc. worn by the athletes.

The system 100 includes VR glasses 106 worn by the players, and maybe by the coach, to view real-time digital media data coming from the cameras on the players, and a software application 108 communicates with the VR glasses 106. The coach 102 is able to view live scenarios on an iPad, lap top, any computer screen, or from the VR glasses 106 he is wearing, or from any combination thereof.

The software application 108 allows the user 102 to interact via a communication platform or social media platform during a practice session or during a live game. Further, the software application 108 communicates messages discussed on the communication platform or social media platform to the VR glass 106. The software application 108 allows the user to interact via a communication platform during the live scenarios of the practice games, practice sessions, or live game. Further, the software application 108 communicates messages discussed on the communication platform with the VR glasses 106.

For exemplary purposes, the users may discuss the advantages and disadvantages of each move made by athletes during the real-time practice or play. Further, the scenario may be a football or basketball game where the player is moving the ball. The users then may discuss on the communication platform about the move.

Thus, the VR glasses 106 display the messages discussed on the communication platform of the software application 108. Thus, allowing the coach 102 to train or manage the players on the field depending upon the messages shared on the social media platform 108. Thus, the present invention is able to assist a coach 102 in managing players in real-time.

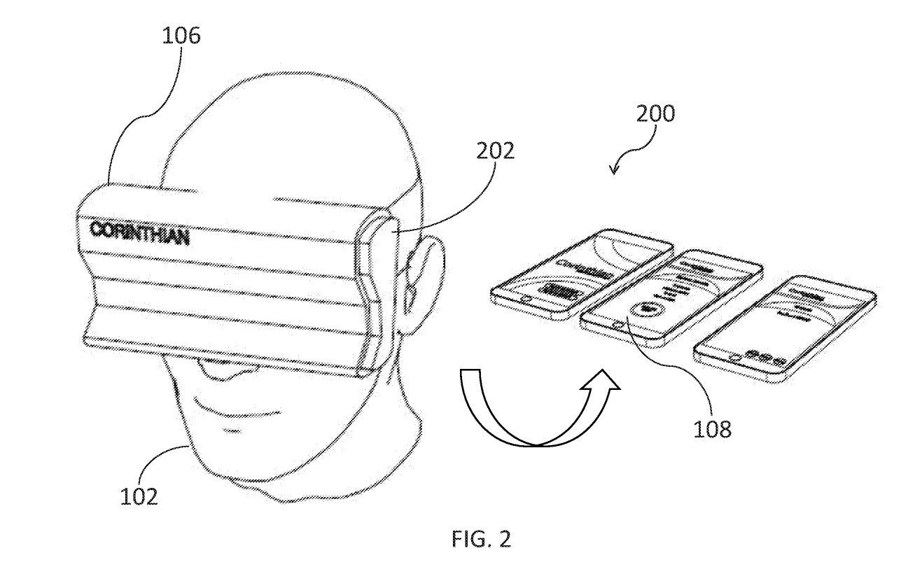

FIG. 2 illustrates one potential embodiment where there is a perspective view of VR glasses 106 worn by the players and/or coach 102 and communicating with the mobile application in accordance with a preferred embodiment of the present invention. The present invention allows the coach 102 to view the practice or live game from the player's perspective. The player's camera sends the digital media to the VR glasses 106 worn by the coach 102. Further, in another preferred embodiment of the present invention, the VR glasses 106 include a hearing aid 202 to send audio messages to the coach 102.

Further, the software application 108 sends the messages on the social media platform to the VR glasses 106, to enable the coach 102 to send the messages. Thus, assisting the coach 102 in managing the players in real-time based upon the feedback of users. Examples of the VR glasses include, but not limited to, Carl Zeiss, Facebook Oculus Rift, Google Cardboard, HTC Vive, Mircosoft Holo Lens, Samsung Gear VR, etc.

In another embodiment of the invention, the system is used to teach children to play against a zone defense in basketball. For example, the children may wear the VR glasses 106 as they walk through different scenarios that are illustrated on the VR glasses 106 in real life. In this fashion, potential real life examples can be practiced and followed by the kids as they follow the images revealed in the VR glasses 106. Whereby, the coach may direct the players via the coaches communication devices, like an iPad, lap top, smart phone, VR glasses, or any other electronic communication device.

Of course, a skilled artisan will realize that most any type of sports training system may use the described invention to train their players. This is important in the situation where a new player is trying to learn a teams set plays and how the new player needs to fit in the new role and new team. Thus, existing plays may be prerecorded from a first person perspective, then the player will put on the VR glasses 106 and walk through the same moves being illustrated in the pre-recorded games or practice sessions.

Many changes, modifications, variations and other uses and applications of the subject invention will, however, become apparent to those skilled in the art after considering this specification and the accompanying drawings that disclose the preferred embodiments thereof. All such changes, modifications, variations and other uses and applications which do not depart from the spirit and scope of the invention are deemed to be covered by the invention, which is to be limited only by the claims which follow.

The embodiments of the invention described herein are exemplary and numerous modifications, variations and rearrangements can be readily envisioned to achieve substantially equivalent results, all of that are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

I/We claim as follows:

1. A system for providing real-time match analysis to assist a coach in changing scenarios from sidelines, further the system receives real-time media data from cameras placed on one or more athletes, the system comprising:
a) a VR glasses worn by the coach to view real-time digital media data from the cameras, the coach is able to view live scenarios of the live game from sidelines of the field; and
b) a software application communicating with the VR glass, the software application allows the user to interact via social media platform on the live scenarios of the live game, further the software application communicates messages discussed on the social media platform to the VR glass;
wherein the VR glass displays the messages discussed on the social media platform of the software application, and further wherein the coach is able to manage the players on the field depending upon the messages shared on the social media platform.

2. The system according to claim 1 wherein the live game is selected from a group consisting of: soccer game; football game; basketball game; baseball game; and tennis.

3. The system according to claim 1 wherein the VR glass further comprising a hearing aid to send audio messages to the coach.

4. A system for providing real-time training of players to assist a coach in training players on how to play a game, the system comprising:
a) a VR glasses worn by the player to view virtual reality game scenarios to play with; and
b) a software application communicating with the VR glasses, allowing the coach to communicate with the player during the player's interaction with the virtual reality gam scenario.

5. The system according to claim 4, wherein the game is selected from a group consisting of: a soccer game; football game; basketball game; baseball game; and tennis.

6. The system according to claim 5, wherein the VR glass further comprising a hearing aid to send audio messages to the coach.
